(19) United States
(12) Patent Application Publication
(10) Pub. No.: US 2008/0118102 A1
(43) Pub. Date: May 22, 2008

(54) Digital data set watermarking method and device implementing said method

(75) Inventors: Severine Baudry, Rennes (FR); Corinne Naturel, Rennes (FR); Philippe Nguyen, Rennes (FR)

Correspondence Address: Joseph J. Laks;Thomson Licensing LLC, 2 Independence Way, Patent Operations, PO Box 5312, PRINCETON, NJ, 08543, US

(73) Assignee: Thomson Licensing

(21) Appl. No.: 11/978,785

(22) Filed: Oct. 30, 2007

(30) Foreign Application Priority Data
Nov. 16, 2006 (FR) 06/54943

(51) Int. Cl. G06K 9/36; G06F 17/30; H04L 27/00

(52) U.S. Cl. 382/100; 375/341; 707/101

(57) ABSTRACT

The invention relates to a digital data set watermarking method including the following steps:
a. Generating, from at least one part of the digital data set, a first set of M n-uplets representative of the digital data set where n and M are integers, M≧1 and n≧1,
b. Determining, in a predefined batch of K n-uplets, a set of M n-uplets, called second set, closest in the sense of predefined metrics to the first set where K is an integer and K≧M, and
c. Modifying at least one data item of the digital data set in such a way that the first set generated according to step a) from the modified data set is equal to the second set.

### 1. SCOPE OF THE INVENTION

The invention relates to a digital data set watermarking method. The invention also relates to a watermarking device implementing said method. In addition, the invention relates to a method for evaluating the quality of the digital data set watermarked using the watermarking method defined above after its processing and/or transmission.

### 2. BACKGROUND OF THE INVENTION

In many technical fields, it is necessary to evaluate the quality of an image, of a video or image sequence, or more exactly the quality degradation resulting from processing operations applied to the video. For instance, during a digital transmission, videos will be compressed (for instance, to the MPEG2 format), inserted in transport streams and broadcasted via satellite or cable, etc. The compression will cause a degradation of the perceptual quality of the video (block effects, noise, etc.) that is all the more important as the rate is low. In addition, when the bit stream is transmitted by satellite it can be noisy and the corresponding MPEG flow may no longer comply. This will result in decoding errors on the receiver side which may have more or less inconvenient consequences: image freeze, black images, erroneous image blocks etc. Therefore, it is often necessary to check the video quality along the transmission chain. This is a costly operation when it is carried out by a human operator all the more as the number of channels to be evaluated is high. This is why it is often preferable to use an automatic system used to evaluate an objective quality. Among the numerous existing quality metrics, one of the simplest is the PSNR (acronym for “Peak Signal Noise Ratio”), defined from the mean square error, noted MSE, between the original video and the altered video. However, it is well-known that this measurement is lightly correlated with the visual quality perceived by man. So, two videos with the same PSNR may correspond to very different subjective qualities. This is why many more or less complex models of the human visual system have been developed (e.g. Watson model, JND, Scott Daly model, etc.), from which quality metrics more advanced than the PSNR have been derived. These metrics are generally closer to the subjective quality perceived by a human being. Therefore, they make it possible to obtain a relatively reliable estimate of the subjective quality of a video. However, most of these metrics operate either with a complete reference, i.e. from the entire original video and altered video, or with a reduced reference, i.e. only from the altered video and a “condensate” of the original video. For instance, during a “monitoring broadcast” application, the quality is measured at the receiver with complete reference metrics. Therefore, it is necessary to convey and process a very large quantity of data, i.e. the reference video, generally not compressed, which implies the availability of very high bitrate links. The problem is less important with reduced reference metrics but all the same requires relatively high bitrates for video “condensate” transmission.

Another well-known technique is to transmit a known video or a pattern over the transmission channel, for instance at regular time intervals for continuous quality monitoring. The receiver, knowing the original pattern, may reconstruct it before estimating the objective quality by comparing the reconstructed pattern with the transmitted pattern. This solution makes it possible to avoid implementing an auxiliary high bitrate channel. The pattern may be chosen so that some artifacts (e.g. spatial/colorimetric/frequency sensitivity) are measured accurately. However, such a technique cannot be used in practice, since it involves deleting the useful video signal and it is very intrusive, showy, i.e. that it significantly interferes with the useful video signal.

### 3. SUMMARY OF THE INVENTION

The purpose of the invention is to compensate for at least one disadvantage of the prior art.

The invention relates to a digital data set watermarking method including the following steps:
a. generating, from at least one part of the digital data set, a first set of M n-uplets representative of the digital data set where n and M are integers, M≧1 and n≧1,
b. determining, in a predefined batch of K n-uplets, a set of M n-uplets, called second set, closest in the sense of predefined metrics to the first set where K is an integer and K≧M, and
c. modifying at least one data item of the digital data set in such a way that the first set generated according to step a) from the modified data set is equal to the second set.

According to one particular embodiment, the determination step of the second set is preceded by a quantization step with N quantizers of each of the n-uplets of the first set in N quantized n-uplets, where N is an integer and N≧2 and in which the predefined batch is a subset of the quantized n-uplets or the set of the quantized n-uplets.

According to a preferred embodiment, step b) consists in a Viterbi decoding which advantageously makes it possible to carry out an exhaustive decoding for a relatively low complexity.

According to one particular embodiment, the digital data set is an image.

Preferentially, the image is divided in non-overlapping pixel blocks, n is equal to 1 and each 1-uplet of the first set is equal to the difference between the average luminance of a first image block and the average luminance of a second image block, the second block being adjacent to the first one and located below the first block.

According to a particular characteristic, N=2.

In addition, the invention relates to a quality evaluation method after transmitting and/or processing of a digital data set watermarked using the watermarking method described above. It comprises the following steps:.

a. generating, from at least one part of the digital data set, a first set of M n-uplets representative of the digital data set where n and M are integers, M≧1 and n≧1;
b. determining, in a predefined batch of K n-uplets, a set of M n-uplets, called second set, closest in the sense of predefined metrics to the first set where K is an integer and K≧M, and
c. estimating the quality of the transmitted and/or processed digital data set by calculating the distance between the first set and the second set.

Preferentially, the determination step of the second set is preceded by a quantization step with N quantizers of each of the n-uplets of the first set in N quantized n-uplets, where N is an integer and N≧2 and in which the predefined batch is a subset of the quantized n-uplets or the set of the quantized n-uplets.

The invention also relates to a device for watermarking a set of digital data, including:
a first unit for generating, from at least one part of the digital data set, a first set of M n-uplets representative of the digital data set where n and M are integers, M≧1 and n≧1,
a second unit for quantifying with N quantizers each of the n-uplets of the first set in N quantized n-uplets, where N is an integer and N≧2,
a third unit for determining, in a subset of quantized n-uplets or in the set of quantized n-uplets, a set of M n-uplets, called second set, closest in the sense of a predefined metrics to the first set,
a fourth unit for modifying at least one data item of the digital data set in such a way that the first set generated by the first unit from the modified data set is equal to the second set.

Preferentially, the third unit comprises a Viterbi decoder.

### 4. BRIEF DESCRIPTION OF THE DRAWINGS

The invention will be better understood and illustrated by means of advantageous embodiments and implementations, by no means limiting, with reference to the figures attached in the appendix, wherein:

FIG. 1 illustrates a watermarking method according to the invention,

FIG. 2 represents a video sequence image divided into pixel blocks,

FIG. 3 illustrates part of the watermarking method according to the invention,

FIG. 4 illustrates a method used to evaluate the quality of a digital data set watermarked using the watermarking method of FIG. 1, and

FIG. 5 illustrates a watermarking system according to the invention.

### 5. DETAILED DESCRIPTION OF PREFERRED EMBODIMENTS

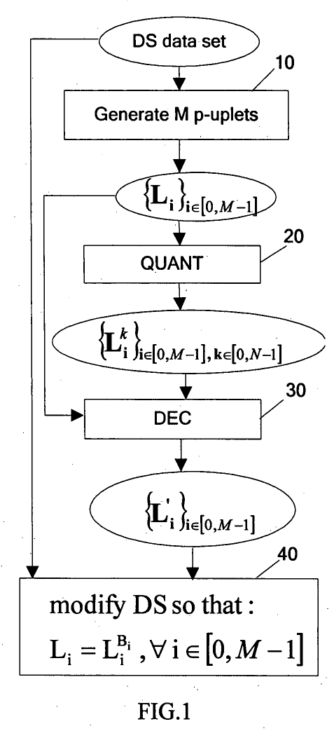

In reference to FIG. 1, the invention relates to a method used to watermark a digital data set such as video data, audio data or more generally multimedia data. This watermarking method is advantageously used by a evaluation method of the quality of said digital data set after its transmission and/or processing, e.g. compression. On this figure, the represented modules are functional units, which may or may not correspond to physically distinguishable units. For example, these modules or some of them can be grouped together in a single component, or constitute functions of the same software. On the contrary, some modules may be composed of separate physical entities. The invention described within the framework of video digital data may apply to other data such as audio data or multimedia data.

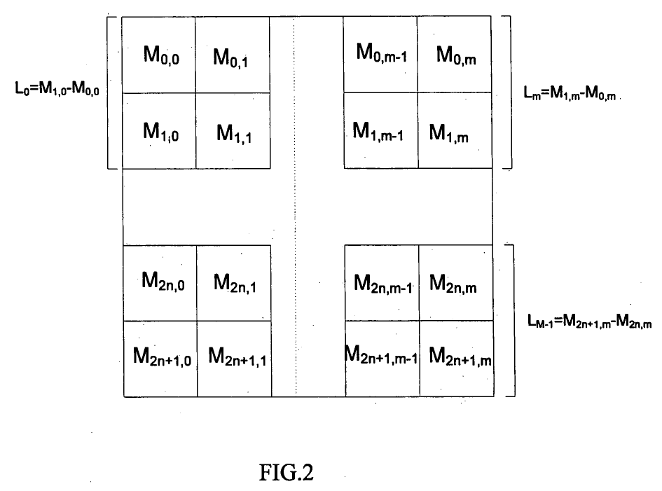

Step 10 consists in generating from the DS initial digital data set a first set {Lᵢ}_{iε[0,M-1]} of M p-uplets representative of the DS data set, where M and n are positive integers equal to or greater than 1. An embodiment is illustrated by FIG. 2 in the special case of digital data of the video type. On this figure, an image is divided into blocks B_{T} of size H by W pixels, said BT blocks not overlapping. In this example, p=1, i.e. each 1-uplet Lᵢ comprises a single digital value also noted Lᵢ. Each value Lᵢ is equal to the difference between the average luminance M_{2i,j} of a first block B_{T} and the average luminance M_{2i+1,j} of a second block B_{T} located just below said first block, i.e. L₀=M_{1,0}−M_{0,0}, . . . , Lₘ₋₁=M_{2n+1,m}−M_{2n,m}, where M_{i,j} is the average luminance of the B_{T} block of coordinates (i, j). For an image of size 720 by 576 pixels, using B_{T} blocks of size 32 by 32 pixels is advantageous. The second block is adjacent to the first block and is located below this first block. According to a variant, each value Lᵢ is calculated from the average luminances calculated for P blocks collocated in P video consecutive images, i.e. L₀=M_{1,0}−M_{0,0} . . . , L_{M-1}=M_{2n+1,m}−M_{2n,m}, where M_{i,j} is the average luminance of N blocks B_{T} of coordinates (i, j) belonging to P consecutive images. More generally, the first set of M p-uplets can be generated from digital data transformed beforehand, for instance from wavelet coefficients or DCT (acronym for “Discrete Cosine Transform”) coefficients. According to another variant, a p-uplet Lᵢ comprises at least two digital values. For instance, a p-uplet Lᵢ generated from a B_{T} block of the image comprises the luminance values associated with each pixel of the B_{T} block. In this case, p=H*W.

Step 20 consists in quantifying each of the M p-uplets Lᵢ with N quantizers in N quantized p-uplets, i.e. N quantized p-uplets Lᵢ^{k},kε[0,N−1] are generated from each p-uplet Lᵢ. In the special case where N=2 and where each p-uplet comprises a single digital value Lᵢ, the two quantization functions are defined as follows:

Lᵢ⁰=Qₚq(Lᵢ+t₁)+Qₚ/2−t₁

Lᵢ¹=Qₚq(Lᵢ+t₂)+Qₚ/2−t₂

where:—

$$q ( x ) = E ( \frac{x}{{Q}_{P}} ) if … , q ( x ) = E ( \frac{x + 1}{{Q}_{P}} ) - 1 if x < 0 ,$$

i.e. q is the integer part function of x/Q; and
Qₚ is the quantization step, for example Qₚ=1.

Preferably, t₂=t₁+Qₚ/2 such that the distance between the two quantizers is maximum. In particular, the two following quantization functions may be used:

$${L}_{i}^{0} = {Q}_{p} q ( {L}_{i} - \frac{{Q}_{P}}{4} ) + 3 \frac{{Q}_{P}}{4}$$

$${L}_{i}^{1} = {Q}_{p} q ( {L}_{i} + \frac{{Q}_{P}}{4} ) + \frac{{Q}_{P}}{4}$$

According to a particular embodiment, a uniform quantization is used. Preferably, the two quantization functions are offset by Qₚ/2. Indeed, a compression of the MPEG type will quantify the signals under the kQ′ form. If the quantization used in step 20 quantizes the signal under the kQₚ form with Qₚ close to Q′, then the compression has little impact on the watermarking. Hence, detecting degradations due to compression is more difficult. Therefore, it is preferable to set quantized values at the maximum distance of the values to which they tend due to the effect of a strong compression, i.e. with a high quantization step.

According to one variant, a dead zone quantization is used. In this case, each value Lᵢ is for instance quantized as follows:

$${L}_{i}^{0} = {Q}_{1} ( {L}_{i} - \frac{{Q}_{P}}{2} ) + 3 * \frac{{Q}_{P}}{4}$$

$${L}_{i}^{1} = {Q}_{1} ( {L}_{i} + \frac{{Q}_{P}}{2} ) + \frac{{Q}_{P}}{4}$$

where Q₁(x)=Qₚ·q(x).

In the case where each p-uplet Lᵢ comprises more than one digital value, a vector quantization is applied at step 20 instead of a scalar quantization. For that purpose, a scalar quantizer product (i.e. one per digital value of each p-uplet), a lattice quantizer or a random quantizer may be used.

Step 30 consists in determining in a predefined batch of sets of M p-uplets, also called dictionary, the set {L′ᵢ}_{iε[0,M-1]} closest in the sense of predefined metrics to the first set {Lᵢ}_{iε[0,M-1]} of M p-uplets. A first embodiment consists in carrying out a Viterbi decoding. For that purpose, a dictionary formed by all the words of the parameter convolutional code, (3,2) is defined. Such a decoding is well known by those skilled in the art of digital communications. It is described in particular in the work called “Digital Communications” from J. Proakis published by Mc Graw Hill. It consists in browsing a lattice, the nodes (also called states) of which correspond to the internal states of the encoder and the transitions (also called branches) of which connecting 2 states of the lattice correspond to the permitted transitions between 2 states. The input symbol and the sequence of corresponding output symbols are associated with each transition. In the simplest lattices, each state comprises 2 transitions corresponding to the possible input bits 0 or 1. For a word to be decoded, the transition scores correspond to the “distance” between the symbols of the word to be decoded and the output symbols for the given branch. The parameters of the Viterbi lattice are noted (r,q), where r represents the channel memory. The more r is high the more the coding/decoding is robust but the longer are the processing operations. Preferably r=3 and q=2. In the particular case where N=2 and where each p-uplet comprises a single digital value Lᵢ, the relative distances from Lᵢ to Lᵢ⁰ and to Lᵢ¹ are used to calculate metrics noted x, for instance in the following way:

$${x}_{i} = \frac{2 * ( {L}_{i} - {L}_{i}^{0} )}{{L}_{i}^{1} - {L}_{i}^{0}} - 1$$

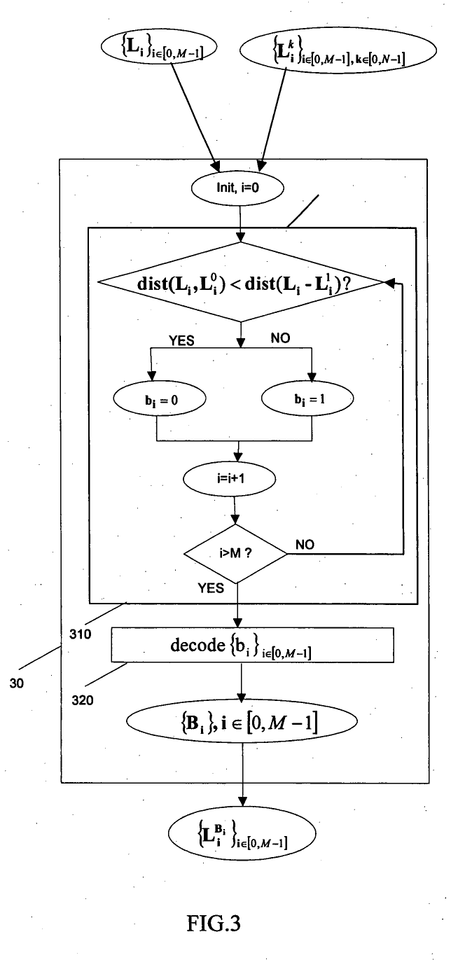

xᵢ is positive if Lᵢ is closer to Lᵢ¹ and negative if Lᵢ is closer to L₁⁰. These metrics are associated with the lattice branches on which the Viterbi algorithm is performed. Other metrics which take account of a psycho-visual model for instance may be used. These metrics may also change along the decoding lattice to weigh differently the importance of the different decoded bits (which may for instance correspond to different frequency coefficients). These metrics associated with the branches are also called transition score. The Viterbi algorithm is used to determine the most probabilistic lattice configuration considering the predefined metrics, i.e. the binary word {Bᵢ}_{iε[0,M-1]} belonging to the predefined dictionary which is the closest to the first set of M p-uplets in the sense of said metrics. A second set {L′ᵢ}_{iε[0,M-1]} of M p-uplets is directly deduced from this binary word in the following way: ∀iε[0,M−1],L′ᵢ=Lᵢ^{B}^{ᵢ}. Therefore, this second set is the closest to the first set of M p-uplets generated at step 10 in the sense of the metrics defined above. According to a variant illustrated by FIG. 3 in the case where N=2, each Lᵢ is 310 demodulated in a bit bᵢ which is worth ‘0’ if Lᵢ is closer to Lᵢ⁰ and which is worth ‘1’ if Lᵢ is closer to Lᵢ¹. The binary word {bᵢ}_{iε[0,M-1]} obtained in this way is then 320 decoded in a word {B₁}_{iε[0,M-1]} by the Viterbi decoding algorithm with the following metrics for instance: +1; −1 (for bits 1 and 0). From this word {Bᵢ}_{iε[0,M-1]}, the second set {L′ᵢ}_{iε[0,M-1]} of M p-uplets is deduced. Any type of code may be used for step 30, i.e. convolutional, algebraic, random. Likewise, any type of decoding may be used provided that the decoding is exhaustive. The advantage of using a convolutional code decoded by Viterbi is the ability to carry out an exhaustive decoding for a relatively low complexity.

### If xε[−1,1] then T_{B}(x)=B*x

### If |x|>1 then if B>0, T_{B}(x)=(s+1)−s*x, otherwise T_{B}(x)=(−s+1)−s*x.

Step 40 of the watermarking method then consists in modifying at least one data item of the DS initial digital data set in such a way that a first data set generated according to step 10 from the data set modified in this way, is equal to the second set of M p-uplets. More precisely, this step 40 consists in modifying according to the second set of M p-uplets determined at step 30 at least one data item of the digital data set in such a way that ∀iε[0,M−1]Lᵢ=L′ᵢ. In the particular case where Lᵢ is equal to the difference between the average luminance M_{2k,j} of a first block B_{T} and the average luminance M_{2k+1,j} of a second block B_{T} located just below said first block, M_{2k,j} can be modified for instance if Lᵢ-L′ᵢ is positive and M_{2k+1,j} if Lᵢ-L′ᵢ is negative. If Lᵢ-L′ᵢ is positive,

$$\frac{{L}_{i} - {L}_{i}^{′}}{HW}$$

for example will be added to the luminance value of each pixel of the block M_{2k,j}. Since this quantity is generally not an integer, a different quantity can be added to the luminance value of each pixel so that the relation Lᵢ=L′₁ is strictly verified.

This watermarking method makes it possible to impose the slightest possible modification of the DS initial digital data set in agreement with the lattice. Advantageously, it is used to maximize the watermarking invisibility while imposing a robust modification to the modifications undergone during the processing and/or transmission. This robustness depends on the lattice parameters.

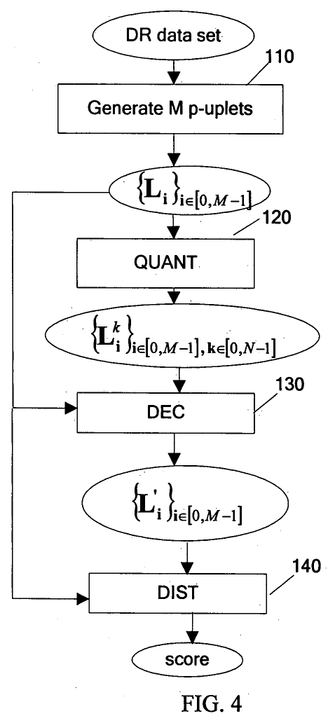

The invention also relates to a quality evaluation method after transmitting and/or processing of a digital data set watermarked using the watermarking method defined above. For this purpose, in reference to FIG. 4, the method comprises a step 110 which consists in generating, from the DR digital data set watermarked according to the method described above and transmitted and/or processed, a first set of M p-uplets {Lᵢ}_{iε[0,M-1]} representative of the DR data set, where M is a positive integer and M≧1. Each p-uplet generated in this way comprises at least one digital value. The step 110 is the same step as step 10 of the watermarking method applied to the DS initial digital data set before transmission and/or processing.

Step 120 consists in quantifying each of the M p-uplets Lᵢ with N quantizers in N quantized p-uplets, i.e. N quantized p-uplets Lᵢ^{k},kε[0,N−1] are generated from each p-uplet Lᵢ. Step 120 is the same step as step 20 of the watermarking method applied before transmission and/or processing.

Step 130 consists in determining in a predefined batch of M p-uplets sets the set {L′ᵢ}_{iε[0,M-1]} closest in the sense of predefined metrics to the first set of M p-uplets. Step 120 is, preferably, the same step as step 30 of the watermarking method applied before transmission and/or processing.

Step 140 consists in calculating a score representative of the quality of the processed and/or transmitted DR data set. In the case where each Lᵢ value is equal to the difference between average luminance M_{2i,j} of a first block B_{T} and average luminance M_{2i+1,j} of a second block B_{T} located just below said first block, the Viterbi algorithm is used to evaluate the deformation of the differences of the average values of consecutive vertical blocks. A score is calculated by averaging these estimates over the entire image. According to a variant, the score is calculated as being the minimum value of these estimates. The calculated score is almost constant for images of the same shot in the case where there is no event, i.e. no quality degradation. Therefore, a reduction of the score corresponds either to a shot change or to an event. This score will be the score chosen for event detection. To complete this detector, a shot change detector can be associated with it so that a discrimination can be made between shot change cases and event cases. An event corresponds to the case where there is a reduction of the score whereas there is no shot change.

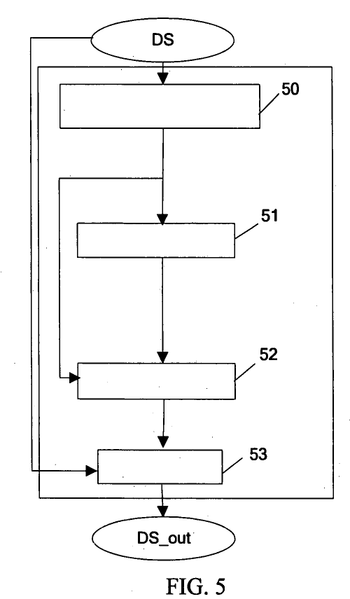

A suitable watermarking system 5 to implement the watermarking method described above is illustrated by FIG. 5. It includes in particular a suitable module 50 to generate from the DS initial digital data set a first set {Lᵢ}_{iε[0,M-1]} of M p-uplets representative of the DS data set, where M and n are positive integers equal to or greater than 1. It also includes a suitable module 51 to quantize each of the M p-uplets Lᵢ with N quantizers in N quantized p-uplets, noted Lᵢ^{k},kε[0,N−1]. In addition, the system 5 includes a suitable module 52 to determine in a predefined batch of M p-uplets sets, also called dictionary, the set {L′ᵢ}_{iε[0,M-1]} closest in the sense of predefined metrics to the first set {Lᵢ}_{iε[0,M-1]} of M p-uplets. It also includes a suitable module 53 to modify at least one data item of the DS initial digital data set into DS_out modified data in such a way that a first data set generated by the module 50 from the set of data modified in this way is equal to the second set of M p-uplets. According to a particular embodiment the module 52 includes a Viterbi decoder.

Naturally, the invention is not limited to the embodiment examples mentioned above. In particular, the person skilled in the art may apply any variant to the stated embodiments and combine them to benefit from their various advantages. In particular, the invention may be generalized to a non-uniform quantizer, i.e. the quantization steps of which vary. For instance, low values may be quantized more finely to take robustness and/or visibility criteria into account. If we work on p-uplets of DCT coefficients, Qₚ may be varied according to the frequency of said coefficients in order to take account of the fact that the high frequency coefficients are less visible/robust.

In general, the method may be used to determine the quality of a signal other than a video signal for instance an audio signal.

The invention is advantageously used for real-time transmission channel monitoring applications.

What is claimed, is:

1. A digital data set watermarking method comprising the following steps:
a. generating, from at least one part of said digital data set, a first set of M n-uplets representative of said digital data set where n and M are integers, M≧1 and n≧1,
b. determining, in a predefined batch of K n-uplets, a set of M n-uplets, called second set, closest in the sense of a predefined metric to said first set where K is an integer and K≧M, and
c. modifying at least one data item of said digital data set in such a way that said first set generated according to step a) from said modified data set is equal to said second set.

2. A method according to claim 1, wherein the determination step of said second set is preceded by a quantization step with N quantizers of each of said n-uplets of said first set in N quantized n-uplets, where N is an integer and N≧2 and in which said predefined batch is a subset of said quantized n-uplets or the set of said quantized n-uplets.

3. A method according to claim 1, wherein step b) consists in a Viterbi decoding.

4. A method according to claim 1, wherein said digital data set is an image.

5. A method according to claim 4, wherein said image is divided into non-overlapping pixel blocks, n is equal to 1 and in which each 1-uplet of said first set is equal to the difference between the average luminance of a first block of said image and the average luminance of a second block of said image, said second block being adjacent to said first block and located below said first block.

6. A method according to claim 1, wherein N=2.

7. A Quality estimation method after transmission and/or processing of a digital data set watermarked using the watermarking method according to claim 1, comprising the following steps:
a. generating, from at least one part of said digital data set, a first set of M n-uplets representative of said digital data set where n and M are integers, M≧1 and n≧1,
b. determining, in a predefined batch of K n-uplets, a set of M n-uplets, called second set, closest in the sense of predefined metrics to said first set where K is an integer and K≧M, and
c. estimating the quality of the transmitted and/or processed digital data set by calculating the distance between the first set and the second set.

8. A method according to claim 7, wherein the determination step of said second set is preceded by a quantization step with N quantizers of each of said n-uplets of said first set in N quantized n-uplets, where N is an integer and N≧2 and in which said predefined batch is a subset of said quantized n-uplets or the set of said quantized n-uplets.

9. A device for watermarking a digital data set comprising:
a first unit for generating, from at least one part of said digital data set, a first set of M n-uplets representative of said digital data set where n and M are integers, M≧1 and n≧1,
a second unit for quantizing with N quantizers each of said n-uplets of said first set in N quantized n-uplets, where N is an integer and N≧2,
a third unit for determining, in a subset of said quantized n-uplets or in the set of said quantized n-uplets, a set of M n-uplets, called second set, closest in the sense of a predefined metrics to said first set,
a fourth unit for modifying at least one data item of said digital data set in such a way that said first set generated by said first unit from said modified data set is equal to said second set.

10. A device according to claim 9, wherein said third unit comprises a Viterbi decoder.
